(19) United States
(12) Patent Application Publication
(10) Pub. No.: US 2026/0070587 A1
(43) Pub. Date: Mar. 12, 2026

(54) LEARNING DRIVING BEHAVIOR CONTROL PARAMETERS USING MACHINE LEARNING MODELS

(71) Applicants: Robert Bosch GmbH, Stuttgart (DE); Carnegie Mellon University, Pittsburgh, PA (US)

(72) Inventors: Arun Balajee VASUDEVAN, Pittsburgh, PA (US); Neehar PERI, Pittsburgh, PA (US); Deva RAMANAN, Pittsburgh, PA (US); Chaithanya KUMAR MUMMADI, Pittsburgh, PA (US); Filipe J. CABRITA CONDESSA, Pittsburgh, PA (US)

(21) Appl. No.: 18/882,013

(22) Filed: Sep. 11, 2024

(51) Int. Cl. B60W 60/00; B60W 50/00; G06N 3/0464

(52) U.S. Cl. CPC B60W 60/00274; B60W 50/0097; B60W 60/0011; B60W 60/0015; G06N 3/0464; B60W 2554/4045; B60W 2554/4046; B60W 2554/80

(57) ABSTRACT

Methods for training a series of neural networks to output driving behavior control parameters is disclosed. The training dataset for the neural networks includes sensor-based vehicle driving recordings that may be categorized by geographical area, by qualitative driving behaviors, or by some combination, such that various training data subsets are used to train the series of neural networks. By learning either city-specific driving behavior control parameters, qualitative driving behavior specific driving behavior control parameters, or both, the resulting parameters may then be provided to a motion planning model for use in modeling predictive control for an autonomous vehicle. Rather than relying on XYZ trajectories of agent vehicles when planning future trajectories of the ego vehicle, the motion planning model is adaptive, due to the use of the learned driving behavior control parameters.

### TECHNICAL FIELD

The present disclosure relates to techniques for training a series of neural networks within a context of machine learning models for autonomous driving.

### BACKGROUND

In recent years, the advancement of machine learning techniques has significantly expanded the scope of problems that can be addressed through computational solutions. Notably, machine learning has found applications in various critical tasks, including but not limited to intelligent transportation, medical image processing, and e-commerce. Given the stringent demands for effectiveness and reliability in these scenarios, it becomes imperative to ensure the training and validity of such machine learning models, particularly in terms of their robustness for autonomous driving applications.

Motion planning is a critical component of that autonomy stack. Computing devices that are configured for use within Autonomous Vehicles (AVs) must carefully plan the motion of the vehicle to navigate in complex urban environments and to safely reach a goal destination while avoiding collisions and abiding by the rules of the road. In the past, motion planners have been typically trained and evaluated in synthetic environments, such as in the cases of CARLA and AirSim. However, such simulated environments notoriously suffer from a sim-to-real gap due to systematic biases and a lack of real-world diversity. Thus, the need to develop more adaptive motion planners remains a challenge for the scientific community at large.

### SUMMARY

Motion planning is crucial for safe navigation in complex urban environments. Historically, motion planners have been evaluated with procedurally-generated simulators. However, such synthetic benchmarks do not capture real-world, multi-agent interactions (e.g., interactions between an ego vehicle and surrounding vehicles). A recently released motion planning benchmark, entitled nuPlan, aims to address this limitation by augmenting real-world driving recordings with closed-loop simulation logic, effectively turning the fixed dataset into a reactive simulator. The present disclosure relates to analyzing the characteristics of nuPlan's recorded logs, which take place in four different cities, in order to deduce that those respective cities have unique or characteristic driving behaviors. Thus, a robust motion planner, such as that which is described herein, should be trained for such environmental differences that depend on geographical areas in order to adapt to each environment.

A series of neural networks are thus trained on the nuPlan benchmark, using those sensor-based, vehicle driving recordings as a training dataset. Specifically, city-specific and/or qualitative driving behaviors are learned using a graph convolutional neural network that predicts reactive agent (e.g., surrounding vehicle) behaviors using features derived from recently-observed agent historical logs. The series of neural networks then outputs driving behavior control parameters, rather than predicting space-time trajectory, as was done in the past. Those driving behavior control parameters are then used as inputs to a motion planning model that models predictive control for an autonomous vehicle, wherein the motion planning model unrolls different world models that have been conditioned on those control parameters.

### BRIEF DESCRIPTION OF THE DRAWINGS

FIG. 1 illustrates a system for training a neural network, according to some embodiments.

FIG. 2 illustrates a computer-implemented method for training and utilizing a neural network, according to some embodiments.

FIG. 3 is a flow diagram that illustrates a process of training a series of neural networks, based on a training dataset that is subdivided based on geographical area, to output driving behavior control parameters that can then be used as inputs to a motion planning model, according to some embodiments.

FIG. 4A illustrates a distribution of minimum distance between an ego vehicle and a surrounding vehicle for sensor-based driving recordings corresponding to the Pittsburgh geographical area, according to some embodiments.

FIG. 4B illustrates a distribution of minimum distance between an ego vehicle and a surrounding vehicle for sensor-based driving recordings corresponding to the Boston geographical area, according to some embodiments.

FIG. 4C illustrates a distribution of minimum distance between an ego vehicle and a surrounding vehicle for sensor-based driving recordings corresponding to the Singapore geographical area, according to some embodiments.

FIG. 4D illustrates a distribution of minimum distance between an ego vehicle and a surrounding vehicle for sensor-based driving recordings corresponding to the Las Vegas geographical area, according to some embodiments.

FIG. 5 illustrates driving behavior control parameters that have been learned by training a series of neural networks on respective geographical areas, according to some embodiments.

FIG. 6 illustrates ego vehicle planned trajectory scores that have been output by a motion planning model that has been trained on different learned driving behavior control parameters, according to some embodiments.

FIG. 7A illustrates a given driving scenario that has been provided to a motion planning model that has been trained using driving behavior control parameters specific to Boston, according to some embodiments.

FIG. 7B illustrates the same driving scenario that was introduced in FIG. 7A that is provided to a motion planning model that has been trained using driving behavior control parameters specific to Pittsburgh, according to some embodiments.

FIG. 7C illustrates another given driving scenario that has been provided to a motion planning model that has been trained using driving behavior control parameters specific to Singapore, according to some embodiments.

FIG. 7D illustrates the same driving scenario that was introduced in FIG. 7C that is provided to a motion planning model that has been trained using driving behavior control parameters specific to Pittsburgh, according to some embodiments.

FIG. 8 is a flow diagram that illustrates a process of training a series of neural networks, based on a training dataset that is subdivided based on qualitative driving behaviors, to output driving behavior control parameters that can then be used as inputs to a motion planning model, according to some embodiments.

FIG. 9A is a t-distributed stochastic neighbor embedding (t-SNE) plot, depicting driving behavior control parameters by city, according to some embodiments.

FIG. 9B is another t-SNE plot, depicting per-scenario driving behavior control parameters by qualitative driving behaviors, according to some embodiments.

FIG. 9C is a plot depicting the portion of agent vehicles within the nuPlan training dataset that exhibit short minimum distances between vehicles, according to some embodiments.

FIG. 9D is a plot depicting the portion of agent vehicles within the nuPlan training dataset that exhibit long minimum distances between vehicles, according to some embodiments.

FIG. 10 depicts a schematic diagram of an interaction between a computer-controlled machine and a control system, according to some embodiments.

FIG. 11 depicts a schematic diagram of the control system of FIG. 10 configured to control a vehicle, which may be a partially autonomous vehicle, a fully autonomous vehicle, a partially autonomous robot, or a fully autonomous robot, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Providing helpful tools to motion planning models has been a non-trivial endeavor for the scientific community. Examples of prior art implementations of rule-based planning pertains to learning robust policies by predicting goal-conditioned way-points, cost-volumes, and/or reward functions. Given the current position, velocity, and distance to the lead vehicle, rule-based planners estimate longitudinal acceleration to safely progress towards the target. The Intelligent Driver Model (IDM), for example, is a classic non-learned algorithm for vehicle motion planning that relies on graph-based search to reach the target while employing a PID velocity controller to avoid collisions with other vehicles.

Moreover, motion planning is often framed as an optimization problem of hand-designed cost functions, which are then minimized to generate an optimal trajectory. To simplify this process, cost functions assume a quadratic objective function or divide the planning task into its lateral and longitudinal components. Approaches such as A*, RRT, and dynamic programming have been commonly used in the past to search for optimal solutions. CoverNet, as another example, generates a set of trajectories and evaluates them based on cost functions, selecting the trajectory with lowest cost. However, these previous attempts to overcome limitations within motion planning are not robust when applied to real-world scenarios, and also require significant hyperparameter tuning. Conventional trajectory optimization approaches typically aim to compute a complete trajectory that spans from the initial configuration to the desired goal configuration. However, given the inherently dynamic and uncertain nature of the driving environment, precise long-horizon motion plans cannot be predicted in advance.

As a result, model-predictive control (MPC) has gained prominence in recent years for real-time path planning because MPC adopts an iterative cost minimization strategy to select a locally optimal trajectory for each timestep. This allows MPC-based algorithms to quickly adapt to changes in the environment.

Furthermore, other learning-based planners have emerged which leverage the availability of simulator environments such as CARLA and AirSim. However, such already outdated simulators are limited because they rely on synthetic data generated from game engines and have insufficient visual fidelity. They also lack the necessary diversity of driving scenarios required for comprehensive training and evaluation.

Other iterations that build upon the Intelligent Driver Model, such as PDM-C, applies a car following algorithm that employs a simple longitudinal PID velocity controller along a reference path. The IDM is modified into an MPC-based planner in this case, but still makes use of a simpler “world-on-rails” internal world model, wherein other agent vehicles within the local environment of the ego vehicle are non-reactive and move with constant velocity during rollouts.

Although a “world-on-rails” model with constant velocity forecasts may provide adequate short-horizon forecasting, it fails to correctly simulate multi-agent interactions like lane changes, lane merges and stopping at traffic lights.

In order to address these challenges, the present disclosure trains a series of neural networks to directly learn driving behavior control parameters, based on a training dataset that includes hours of real-world, sensor-based, vehicle driving recordings. As additionally described below, one example of such a training dataset that may be applied herein is the nuPlan benchmark dataset. This particular training dataset, nuPlan, augments real-world driving logs with closed-loop simulation logic, effectively turning the fixed dataset into a reactive simulator. The benchmark nuPlan includes 1300 hours of real-world driving logs from various cities, including Las Vegas, Boston, Pittsburgh, and Singapore. Driving in each city presents a unique set of driving challenges. For example, Las Vegas has many high density pick-up and drop-off locations, and intersections with 8 parallel driving lanes per direction. In Boston, drivers tend to double-park, creating distinct planning challenges.

By using such a training dataset and incorporating the machine learning architecture described below, the series of neural networks directly predicts driving behavior control parameters, which are then used to unroll a reactive world model, as opposed to previous implementations that use traditional forecasters to determine XYZ coordinates of agent vehicles. This allows for a more robust, adaptive, and reactive motion planning model, as opposed to previous implementations that relied on “world-on-rails” type world models.

The present disclosure continues with a general overview of the computing architecture used to implement neural networks described herein, followed by a detailed discussion on how to train a series of neural networks to learn driving behavior control parameters, which may then be provided to a motion planning model for use in predictive control in a context of autonomous driving. Finally, examples of how such machine learning models may be implemented into an autonomous vehicle system are detailed.

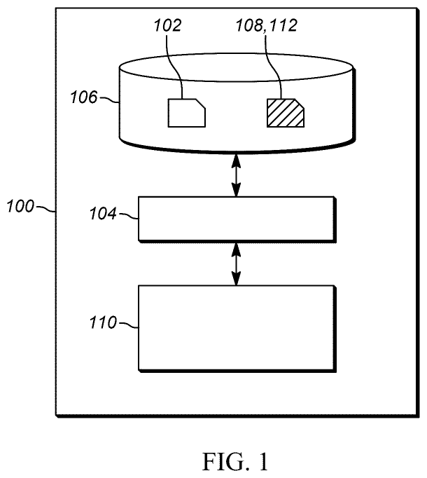

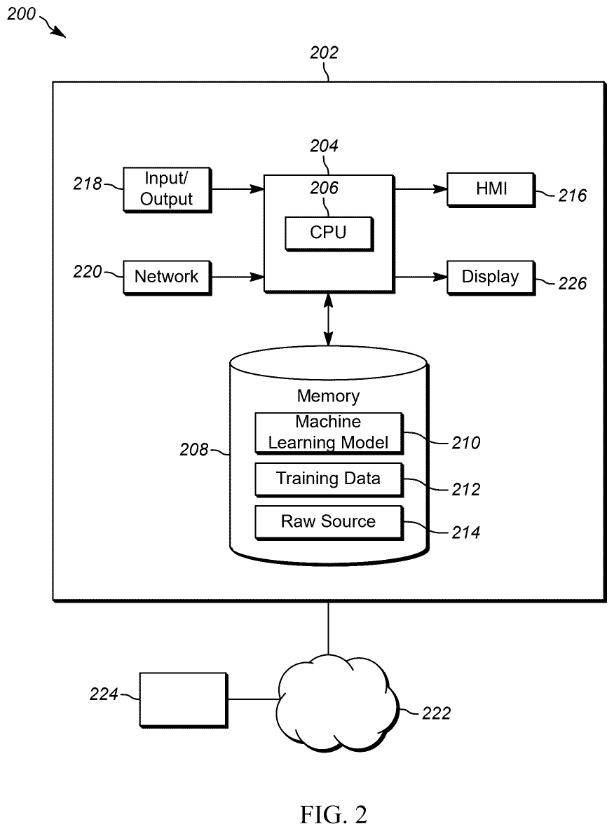

FIG. 1 illustrates a system 100 for training a neural network, such as a deep neural network. It should be understood that, while the example embodiments given in the following paragraphs herein with regard to FIGS. 1 and 2 refer to a deep neural network, additional embodiments of FIGS. 1 and 2 may be applied to any other type of neural-network-based or non-neural-network-based machine learning model that is configured to be developed, trained, and optimized for various computer vision applications that are related to object detection, image classification, image segmentation, etc. For example, the neural network referred to in FIGS. 1 and 2 may refer to an implementation of a classifier, a regression model, a Graph Convolutional Neural Network (GCNN), a Feature Pyramid Network (FPN), or a Multilayer Perceptron (MLP).

Moreover, and as related to the description herein, a “deep” learning model, such as a deep neural network, may be defined as having multiple hidden layers (e.g., one, two, or tens of hidden layers) in between an input layer and an output layer of the model. A deep learning model may additionally be used to describe a machine learning model that is configured to learn complex patterns and representations based on training and/or validation datasets that are used as inputs to the machine learning model. Additional embodiments pertaining to such types of machine learning models are described herein with regard to blocks 306, 308, 310, 312, 806, 808, 810, and 812.

In some embodiments, the system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the neural network using the training data 102 (e.g., thus generating updated versions of the machine learning model with respect to a first “untrained” version of the model). Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

FIG. 2 illustrates a computer-implemented method for training and utilizing a neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 214.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 214. The raw source dataset 214 may include raw or unprocessed sensor data that may be representative of an input dataset for a machine learning system. The raw source dataset 214 may include video, video segments, images, text-based information, and raw or partially processed sensor data (e.g., radar map of objects). In some examples, the machine learning algorithm 210 may be a neural network algorithm that is designed to perform a predetermined function. For example, the neural network algorithm may be configured to learn driving behavior control parameters that are to be used as inputs to a motion planning model.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a neural network algorithm. The training dataset 212 may include a set of source data that has corresponding outcomes or results that the machine learning algorithm 210 tries to duplicate via the learning process. In this example, the training dataset 212 may include sensor-based vehicle driving recordings within the nuPlan training dataset of various driving environments in various geographical areas around the world.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. For example, the machine learning algorithm 210 may be configured to learn a range of acceleration and deceleration of surrounding vehicles within the driving recordings, as further described below. The machine learning algorithm 210 may be programmed to process the raw source data 214 to identify the presence of the particular features. The machine learning algorithm 210 may be configured to identify a feature in the raw source data 214 as a predetermined feature (e.g., an agent or surrounding vehicle, from the perspective of the ego vehicle that has logged sensor data about its local environment). The raw source data 214 may be derived from a variety of sources. For example, the raw source data 214 may be actual input data collected by a machine learning system. The raw source data 214 may be machine generated for testing the system. As an example, the raw source data 214 may include raw video images from a camera.

In the example, the machine learning algorithm 210 may process raw source data 214 and output driving behavior control parameters. A machine learning algorithm 210 may generate a confidence level or factor for each output generated. For example, a confidence value that exceeds a predetermined high-confidence threshold may indicate that the machine learning algorithm 210 is confident that the identified feature corresponds to the particular feature. A confidence value that is less than a low-confidence threshold may indicate that the machine learning algorithm 210 has some uncertainty that the particular feature is present.

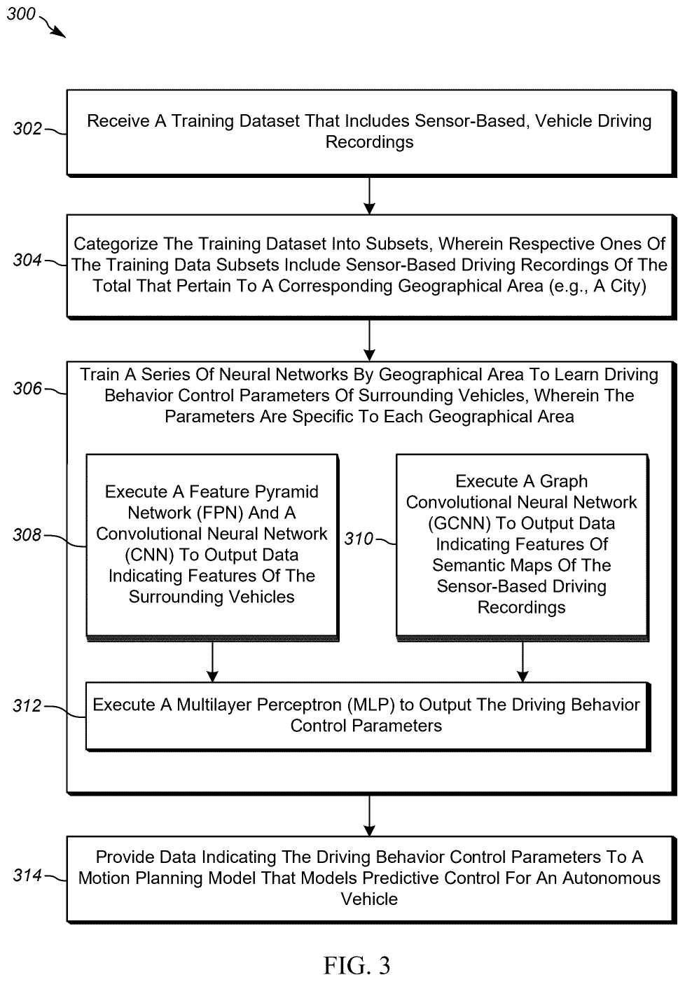

FIG. 3 is a flow diagram that illustrates a process of training a series of neural networks, based on a training dataset that is subdivided based on geographical area, to output driving behavior control parameters that can then be used as inputs to a motion planning model, according to some embodiments.

As introduced above, and in order to train a motion planning model that incorporates city-specific driving behaviors and qualitative-specific driving behaviors into the decision making process, thus enabling the motion planning model to output a proposed trajectory of an ego vehicle that is both safe and that abides by said city-specific and qualitative-specific driving behaviors, the following process 300 may be executed.

The following few paragraphs first define certain words and key phrases that should be applied when used within the present disclosure herein. The discussion will then continue with description pertaining to process 300.

As used herein, an “ego” vehicle refers to a vehicle that includes one or more sensors that are configured to perform any of the following operations: take images of the environment surrounding the vehicle, record video of the environment surrounding the vehicle, record sound of the environment surrounding the vehicle, determine acceleration/deceleration of the vehicle, and determine velocity of the vehicle. An example of an ego vehicle 1100 with one or more sensors 1006 is illustrated in FIG. 11. Furthermore, an “agent” vehicle refers to a vehicle that is in close proximity to the ego vehicle (e.g., within a same local environment as the ego vehicle). Using the sensors included within the ego vehicle, a distance between the ego vehicle and the surrounding agent vehicle(s) may be determined, for example.

As additionally used herein, a “geographical area” refers to a city, county, or any other designated region of the world that refers to an area with a radius of at least 100 m from the current location of the vehicle. In some embodiments in which the ego vehicle additionally includes a computing device that provides a GPS location of the ego vehicle, then the geographical area may therefore refer to a surrounding environment (e.g., at least 100 m in any given direction) or vicinity of that GPS location, which thus may be updated as the ego vehicle moves through the real-world. Examples of geographical areas herein may refer to Pittsburgh, Boston, Singapore, and Las Vegas metropolitan areas.

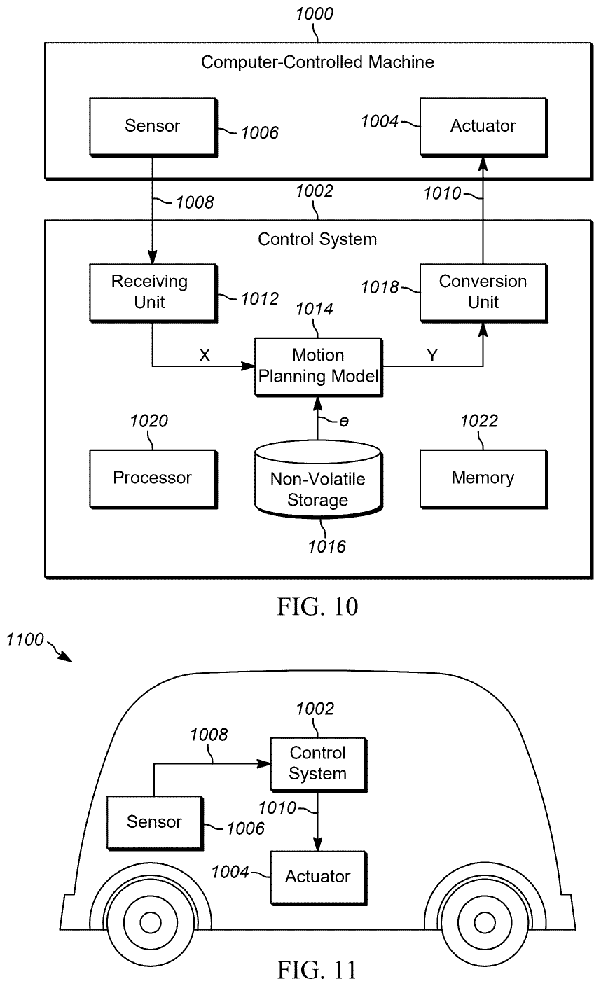

Returning now to the flow diagram illustrated in FIG. 3, process 300 corresponds to a moment in time in which a series of neural networks being trained to output driving behavior control parameters. It should be understood that the execution of the motion planning model (see also reference to the motion planning model in block 314 of FIG. 3) thus corresponds to a later moment in time in which the motion planning model is predicting a high-scoring trajectory for the ego vehicle that is currently on the road. The incorporation of computing devices that execute the trained motion planning model are further discussed with regard to FIGS. 10 and 11 herein.

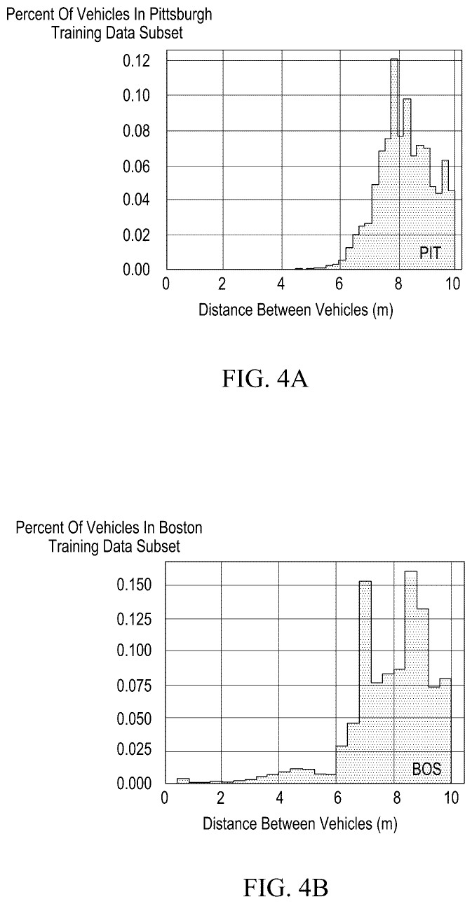

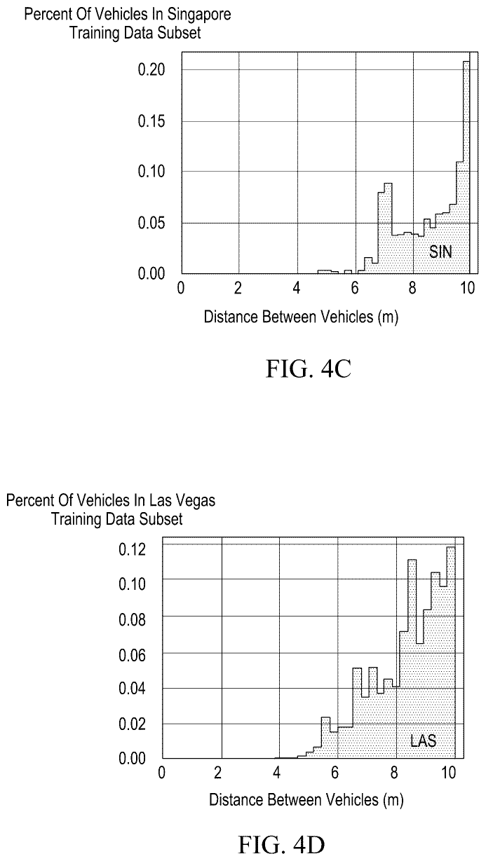

In block 302, computing system 202 is configured to receive a training dataset that includes sensor-based, vehicle driving recordings. In some embodiments, and as additionally illustrated in FIGS. 4A-7D and FIGS. 9A-9D herein, the training dataset may refer to the nuPlan benchmark dataset. For ease of discussion herein, references below may refer to the “training dataset” as a given implementation of the present disclosure in which the nuPlan sensor-based vehicle driving recordings are utilized as said training dataset. However, other embodiments in which a different training dataset is applied in process 300 and/or appended to the nuPlan training dataset in process 300 may also be encompassed in the discussion herein, wherein the other training dataset includes sensor-based vehicle driving recordings of various geographical areas and under various driving scenarios, and thus may similarly be used to train a series of neural networks.

The nuPlan training dataset includes real-world driving logs that have been augmented with closed-loop simulation logic, thus allowing other agents to react to the ego vehicle. Agent vehicles are instantiated with respective initial velocities based on their trajectory histories, and thus their spatial trajectories can be re-simulated from the sensor-based vehicle driving recordings. A closed-loop simulation logic for respective ones of the agent vehicles are then initialized with a fixed target velocity, a minimum distance between the given agent vehicle and the ego vehicle, a given headway time between the given agent vehicle and the ego vehicle, a maximum acceleration of the agent vehicle, and a maximum deceleration of the agent vehicle.

Furthermore, the nuPlan training dataset includes approximately 10 million sensor-based, vehicle driving records that were collected in four different geographical areas: Pittsburgh, Boston, Singapore, and Las Vegas. The driving scenarios within the nuPlan training dataset include driving scenarios that are typically seen in city environments, and include scenarios such as lane changes, a starting left turn, an unprotected right turn, and other road-based and/or intersection-based scenarios.

Moreover, the sensor-based, vehicle driving records of the nuPlan training dataset are augmented with metadata about one or more of the following, depending upon a given driving scenario: a semantic map, object(s) within a local environment of the ego vehicle, observed driving scenario types (e.g., rush hour traffic, four-way intersection, highway ramp, etc.), or a status of a traffic light. For example, in a given driving scenario in which the ego vehicle is approaching a traffic light at an intersection, the “status” of the traffic light refers to whether the traffic light is currently red, yellow, or green. The sensor-based, vehicle driving recordings of the nuPlan training dataset are also auto-labeled using an offline perception system in order to differentiate between different objects within the local environment of the ego vehicle, such as the other surrounding vehicles on the road or parked nearby, a bicycle, a pedestrian, a traffic cone, a barrier, or a construction zone sign.

In block 304, the sensor-based vehicle driving recordings within the nuPlan training dataset are subdivided into multiple categories, wherein the different categories correspond to different geographical areas. For example, the portion of the overall 10 million sensor-based, vehicle driving recordings that were recorded in the Pittsburgh geographical area are categorized into a first training data subset, while other portions of the overall training dataset that include recordings that took place in the Boston geographical area are categorized into a second training data subset, and so on. By generating several distinct training data subsets, the series of neural networks may then be trained on all of the training data subsets, on a portion of the training data subsets, or on a given training data subset, in order to learn city-specific driving behaviors.

Blocks 306, 308, 310, and 312 refer to a process of training a series of neural networks to learn driving behavior control parameters of agent vehicles within respective vehicle driving recordings, wherein the learned driving behavior control parameters of the agent vehicles are specific to one or more geographical areas within the overall training dataset. By training the series of neural networks on combinations of the respective training data subsets, the models are configured to provide driving behavior control parameters that may then be applied to other cities that were not specifically represented within the training dataset. For example, by providing sensor-based vehicle driving recordings that allow the series of neural networks to learn that tailgating is more commonly observed during rush hour traffic in Boston, the driving behavior control parameters that are outputted may then reflect this observation. Then, when the downstream motion planning model is provided with such driving behavior control parameters and is implemented into an autonomous vehicle in the Dallas geographical area, the motion planning model will learn to apply similar “intangible” driving behaviors to the probability of tailgating that may occur during rush hour traffic in Dallas.

Furthermore, by training the series of neural networks on the respective training data subsets to output respective driving behavior control parameters, it ensures that the downstream motion planning model is both city-agnostic and task-agnostic.

In some embodiments, a “series of neural networks” may refer to one or more machine learning models that are collectively configured to receive a training dataset of sensor-based vehicle driving recordings as inputs and, once executed, collectively output driving behavior control parameters. As illustrated in blocks 308, 310, and 312 of FIG. 3, the series of neural networks may refer to a combination of machine learning models, such as a feature pyramid network (FPN), a convolutional neural network (CNN), a graph convolutional neural network (GCNN), and a multilayer perceptron (MLP). The following paragraphs, however, will firstly discuss the process of training the series of neural networks at a high level, in order to detail the objectives of organizing computing system 202 in this manner.

At a high-level, the training of a series of neural networks in block 306 refers to improving upon prior art methods of an overall process of training a motion planning model, wherein the prior art methods applied “world-on-rails” models to learn XYZ coordinates of agent vehicles, which was then provided to a motion planning model. This was quite limiting, as the motion planning model then only had fixed XYZ coordinate predictions of the agent vehicles to use to plan the motion of the ego vehicle accordingly. In contrast, the present disclosure trains and executes a series of neural networks to predict future agent behaviors, and then provides driving behavior control parameters of the agent vehicles to the motion planning model. This enables the motion planning model to be adaptive and reactive to the local environment of the ego vehicle, and, rather than fixing the expected acceleration, velocity, and XYZ trajectory of each agent vehicle as was done in the past, the present disclosure accounts for both quantitative and qualitative parameters of the local environment. As additionally described below with regard to block 314, the driving behavior control parameters, predicted using the series of neural networks, are then used to unroll a reactive world model, using the motion planning model.

In some embodiments, the training of the series of neural networks is used to model unique driving characteristics pertaining to respective driving scenarios by encoding a vectorized road graph of radius R around the ego vehicle, and two seconds of trajectory history for the surrounding vehicles. The series of neural networks, as additionally illustrated in blocks 308, 310, and 312, may include several multi-scale graph convolution and attention modules, followed by a fully connected layer, which collectively may then be used to output driving behavior control parameter predictions.

Again at a high level, block 306 refers to learning adaptive behavior parameters, wherein the series of neural networks is trained with paired examples of past agent trajectories and target driving behavior control parameters that best explain future agent vehicle actions. The target driving behavior control parameters are optimized by fitting to recordings within the training dataset using a grid search over θ={θ₀, . . . , θ₄}. This may be written as:

$${θ}^{Target} = {arg min}_{θ} {‖ {X}_{SIM} ( θ ) - {X}_{L O G} ‖}_{2}^{2} ,$$

wherein X_{SIM} is defined as the position of agent vehicles in the simulated driving behavior rollout and X_{LOG} is the position of agent vehicles in the sensor-based vehicle driving recordings.

In some embodiments, the ego vehicle may be interpreted as non-reactive and simply replays the corresponding sensor-based vehicle driving recording, as it is a recording from the perspective of the ego vehicle.

Moreover, codebases of PDM-C and nuPlan may be adapted in order to execute the series of neural networks described in process 300. The codebase of PDM-C may be modified by adding additional longitudinal velocities and lateral offsets to the reference path. In addition, additional trajectory proposals are generated by modulating the distance between the ego vehicle and surrounding vehicles, the headway time, the maximum acceleration, and the maximum deceleration. In total, 150 proposals per timestep may be generated. Furthermore, the series of neural networks may be trained for 10 epochs using the Adam optimizer with a learning rate of 5×10⁻⁵. The applied radius R that defines the geographical area is a map context with a radius of R=100 m.

Returning now to the sub-process steps within block 306, an FPN and a CNN are executed in block 308 in order to output data indicating features of agent vehicles (e.g., vehicles within the vicinity of the ego vehicle of the given sensor-based vehicle driving recordings), wherein the features may include past trajectories of the agent vehicles.

In block 310, a GCNN is executed in order to output data indicating features of semantic maps of the sensor-based vehicle driving recordings. This may be at least partially applied using LaneGCN, or some similar type of neural network that is configured to extract map features from a lane graph. The GCNN may additionally be used to model interactions between agent vehicles and the map context (e.g., using LaneGCN's Agent-Map Feature Fusion).

As illustrated in FIG. 3, blocks 308 and 310 may be performed in parallel to one another, sequentially to one another, or by any other means that enables the outputs from both blocks 308 and 310 to then be input to the MLP in block 312.

In block 312, an MLP is executed in order to output the learned driving behavior control parameters. In some embodiments, the learned driving behavior control parameters may include at least the following: (1) a target velocity of an ego vehicle; (2) a minimum distance between the ego vehicle and a given surrounding (e.g., agent) vehicle; (3) headway time between the ego vehicle and the given surrounding vehicle (e.g., time between two vehicles passing a specific point on the road, such as a mile marker); (4) maximum acceleration of the given surrounding vehicle; and (5) maximum deceleration of the given surrounding vehicle. Moreover, these driving behavior control parameters may be bounded, have an upper limit, a lower limit, a threshold, or some combination of bounds on the parameters. For example, “acceleration” may have a lower bound of zero miles per hour, as a negative value would intuitively mean “deceleration.”

As process 300 pertains to training the series of neural networks on training data subsets that have been categorized by geographical area, four sets of learned driving behavior control parameters may be output from the series of neural networks when training said models on the nuPlan training dataset, since four geographical areas are included in the set. Additional examples of city-specific driving behavior control parameters are discussed with regards to FIGS. 4A-4D below.

In block 314, the learned driving behavior control parameters are provided to a motion planning model that models predictive control for an autonomous vehicle. The motion planning model referred to in block 314 goes beyond prior implementations of “world-on-rails” that have been relied upon in the past. The present disclosure predicts future agent vehicle behaviors, parameterized as driving behavior control parameters, using scene context including the ego vehicle's history, past agent vehicle trajectories, and surrounding lane graph or map context. The motion planning model identifies the nearest centerline to the goal using graph-based search. A plurality of ego vehicle trajectory proposals are then generated using the motion planning model, and each is scored according to the reactive world model, implemented using the series of neural networks. The trajectory proposal with the highest score is selected and is used to control the autonomous vehicle. Additional description pertaining to scoring is provided with regard to FIG. 6 herein.

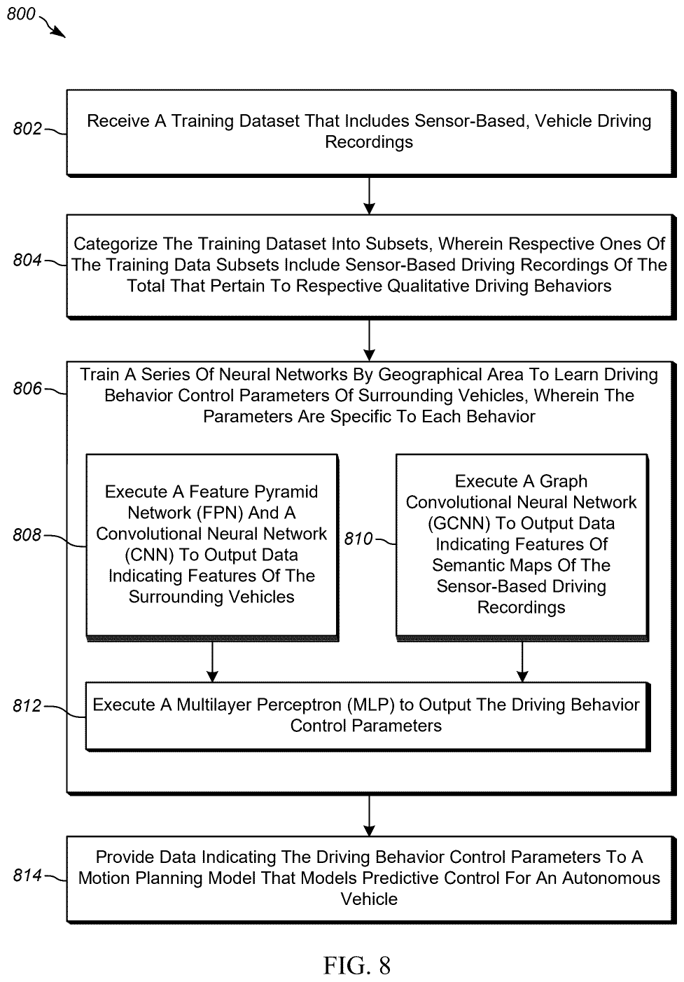

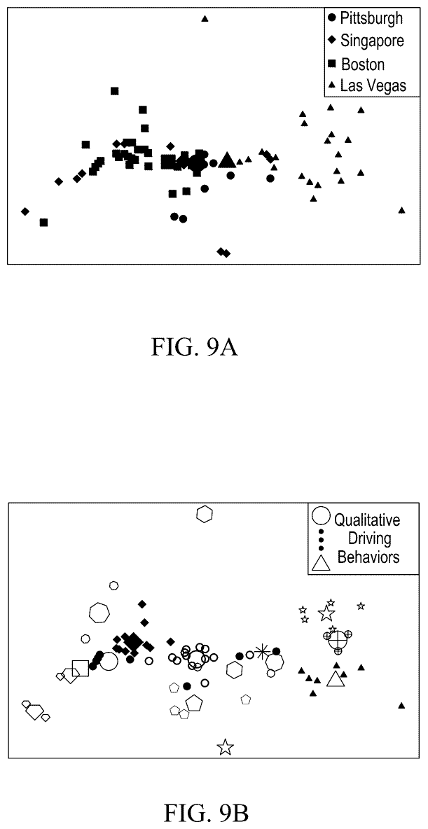

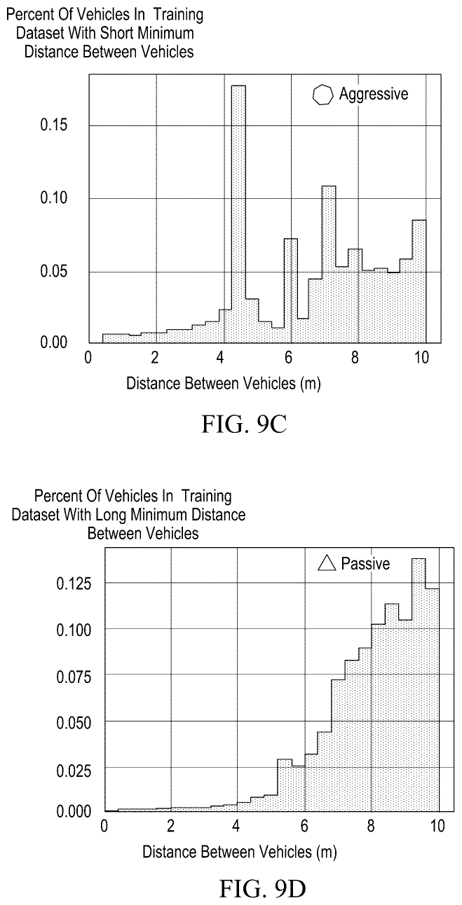

As additionally discussed with regard to FIGS. 8-9D herein, it may be of interest to subdivide the training dataset into multiple types of categories and train the series of neural networks on the different types of categories. For example, process 300 illustrates categorizing the training dataset into training data subsets that each include sensor-based vehicle driving recordings of a given geographical area, and training the series of neural networks on those geographical-area-based training data subsets. In another example, process 800 illustrates categorizing the training dataset into training data subsets that each include qualitative driving behaviors that are observed in respective ones of the sensor-based vehicle driving recordings, and training the series of neural networks on those qualitative-driving-behavior-based training data subsets. In other examples, the training dataset could be categorized into a specific qualitative driving behavior observed within a given geographical area, and the series of neural networks could be trained on those subsets. In yet other examples, the training dataset could be subdivided by individual agent vehicles, in those of the sensor-based vehicle driving recordings that have multiple agent vehicles.

FIGS. 4A, 4B, 4C, and 4D illustrate a distribution of minimum distance between an ego vehicle and a surrounding vehicle for sensor-based driving recordings corresponding to the Pittsburgh geographical area, the Boston geographical area, the Singapore geographical area, and the Las Vegas geographical area, respectively.

As introduced above, five driving behavior control parameters, with respect to a given agent vehicle, are learned using a series of neural networks: a target velocity of the ego vehicle, a minimum distance between the ego vehicle and the surrounding vehicle, the headway time between the ego vehicle and the surrounding vehicle, the maximum acceleration of the surrounding vehicle, and the maximum deceleration of the surrounding vehicle. FIGS. 4A-4D specifically illustrate the learned driving behavior parameter of minimum distance between the ego vehicle and the surrounding vehicle for four different geographical areas. For case of discussion herein, the minimum distance between the ego vehicle and the surrounding vehicle may also be referred to as the minimum gap, for short.

As also introduced above, process step 304 refers to categorizing portions of the overall training dataset into training data subsets by geographical area. Thus, FIG. 4A illustrates the minimum gap between vehicles (in meters) along the X axis vs a percent of the vehicles within the Pittsburgh (PIT) training data subset along the Y axis of the plot. Similarly, FIGS. 4B, 4C, and 4D illustrate the minimum gap between vehicles (in meters) along the X axis vs a percent of the vehicles within the Boston (BOS), Singapore (SIN), and Las Vegas (LAS) training data subsets along the Y axis of the respective plots.

As collectively shown in FIGS. 4A-4D, the distributions of minimum gap between vehicles differs by city. For example, Boston agent vehicles are driven with a lower average minimum gap than the average minimum gap at which Pittsburgh agent vehicles are driven. In terms of interpreting this as a qualitative driving behavior that should be learned by the series of neural networks, the Boston-based training data subset may be used to train the series of neural networks on aggressive driving habits, while the Pittsburgh-based training data subset may be used to train the series of neural networks on passive driving habits.

Thus, robust motion planning models, like those described herein, are able to adapt to diverse driving conditions based on the driving behavior control parameters that are output from the series of neural networks that have been trained for qualitative driving behaviors such as aggressive and passive driving habits.

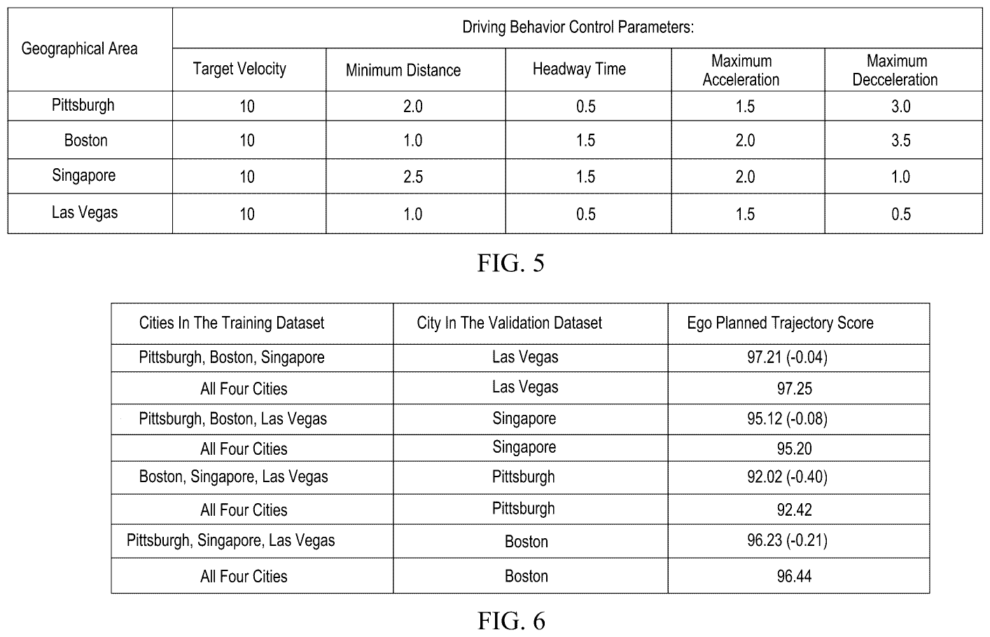

FIG. 5 illustrates driving behavior control parameters that have been learned by training a series of neural networks on respective geographical areas, according to some embodiments.

In some embodiments, by first categorizing the overall nuPlan training dataset into training data subsets that focus on the four geographical areas (e.g., Pittsburgh, Boston, Singapore, and Las Vegas) and then subsequently training the series of neural networks on each of the training data subsets, four sets of driving behavior control parameters are then output from the series of neural networks, wherein each set corresponds to the respective four geographical areas.

As introduced above, each set of learned driving behavior control parameters includes a target velocity of the ego vehicle, a minimum distance between the ego vehicle and a given surrounding vehicle, a headway time between the ego vehicle and the given surrounding vehicle, a maximum acceleration of the surrounding vehicle, and a maximum deceleration of the surrounding vehicle.

The city-specific driving behavior control parameters are further optimized by applying the equation

$${θ}^{Target} = {arg min}_{θ} {‖ {X}_{SIM} ( θ ) - {X}_{L O G} ‖}_{2}^{2}$$

over the training data subsets for the respective cities. The optimized world model parameters thus minimize the distribution shift between simulated trajectory rollouts and sensor-based, vehicle driving recordings.

As shown in the table in FIG. 5, city-specific, qualitative driving behaviors may be deduced from the learned driving behavior control parameters. For example, the minimum distance between an ego vehicle and a surrounding vehicle is shorter in Boston and in Las Vegas than in Pittsburgh and Singapore, thus allowing the downstream motion planning model to determine that driving behavior control parameters from Boston and Las Vegas are examples of aggressive driving and/or of tailgating, while driving behavior control parameters from Pittsburgh and Singapore are examples of passive driving.

FIG. 6 illustrates ego vehicle planned trajectory scores that have been output by a motion planning model that has been trained on different learned driving behavior control parameters, according to some embodiments.

In some embodiments, an ego vehicle planned trajectory score refers to a measurement of (1) progress along an expert trajectory by the ego vehicle, (2) speed limit compliance of the ego vehicle, (3) driving direction compliance of the ego vehicle (e.g., not crossing a center lane into oncoming traffic), (4) time to collision within bounds of the ego vehicle, and (5) a comfortability parameter of the ego vehicle. The overall ego vehicle planned trajectory score is then computed using a weighted sum of the above list of measurements.

The table in FIG. 6 thus illustrates scenarios in which the series of neural networks has been trained on three out of four of the available geographical areas within the training dataset, and the remaining fourth available geographical area is then used for validation of the series of neural networks. Moreover, three out of four possible driving behavior control parameters are then provided to the motion planner model, which is then executed and scored using the remaining fourth available geographical area. As proven in the table, the use of learning driving behavior control parameters using a series of neural networks, which are then input to a motion planning model for adaptive and reactive learning can therefore be generalized to previously unseen cities by holding out city-specific sequences from the training dataset.

In a first example, the first of the top two rows of the table in FIG. 6 illustrates a given implementation of process 300 in which the series of neural networks is trained using training data subsets corresponding to the Pittsburgh, Boston, and Singapore geographical areas, the learned driving behavior control parameters are provided to the motion planning model, and the motion planning model is validated using the Las Vegas training data subset. The second of the top two rows of the table illustrates a comparative implementation of process 300 in which the series of neural networks is trained using the entire training dataset (e.g., all four cities), the learned driving behavior control parameters are provided to the motion planning model, and the motion planning model is validated using the Las Vegas training data subset. As shown in the last column, the ego vehicle planned trajectory scores are within 0.04% of one another.

In a second example, the third row of the table in FIG. 6 illustrates a given implementation of process 300 in which the series of neural networks is trained using training data subsets corresponding to the Pittsburgh, Boston, and Las Vegas geographical areas, the learned driving behavior control parameters are provided to the motion planning model, and the motion planning model is validated using the Singapore training data subset. The fourth row of the table illustrates a comparative implementation of process 300 in which the series of neural networks is trained using the entire training dataset (e.g., all four cities), the learned driving behavior control parameters are provided to the motion planning model, and the motion planning model is validated using the Singapore training data subset. As shown in the last column, the ego vehicle planned trajectory scores are within 0.08% of one another.

In a third example, the fifth row of the table in FIG. 6 illustrates a given implementation of process 300 in which the series of neural networks is trained using training data subsets corresponding to the Boston, Singapore, and Las Vegas geographical areas, the learned driving behavior control parameters are provided to the motion planning model, and the motion planning model is validated using the Pittsburgh training data subset. The sixth row of the table illustrates a comparative implementation of process 300 in which the series of neural networks is trained using the entire training dataset (e.g., all four cities), the learned driving behavior control parameters are provided to the motion planning model, and the motion planning model is validated using the Pittsburgh training data subset. As shown in the last column, the ego vehicle planned trajectory scores are within 0.40% of one another.

In a fourth example, the seventh row of the table in FIG. 6 illustrates a given implementation of process 300 in which the series of neural networks is trained using training data subsets corresponding to the Pittsburgh, Singapore, and Las Vegas geographical areas, the learned driving behavior control parameters are provided to the motion planning model, and the motion planning model is validated using the Boston training data subset. The eighth row of the table illustrates a comparative implementation of process 300 in which the series of neural networks is trained using the entire training dataset (e.g., all four cities), the learned driving behavior control parameters are provided to the motion planning model, and the motion planning model is validated using the Boston training data subset. As shown in the last column, the ego vehicle planned trajectory scores are within 0.21% of one another.

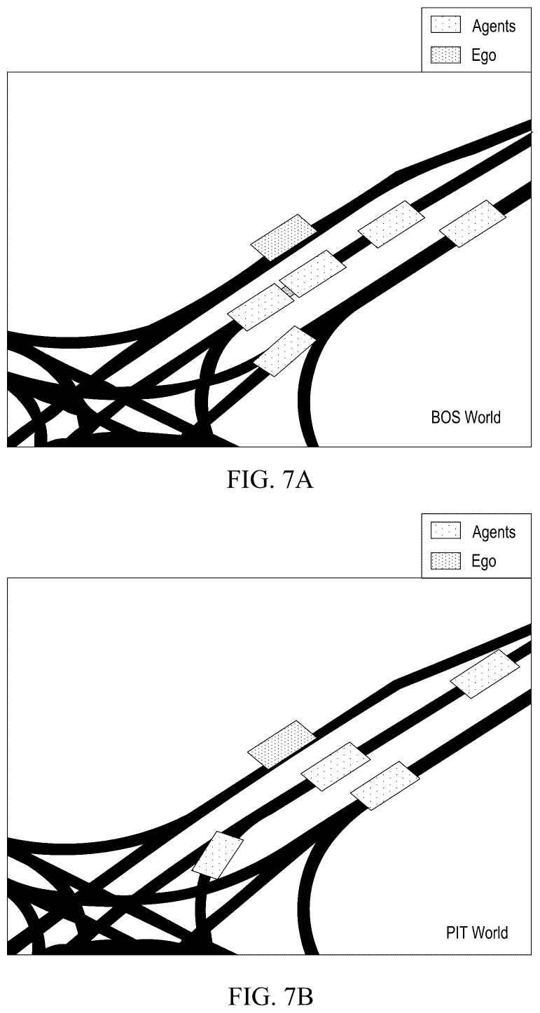

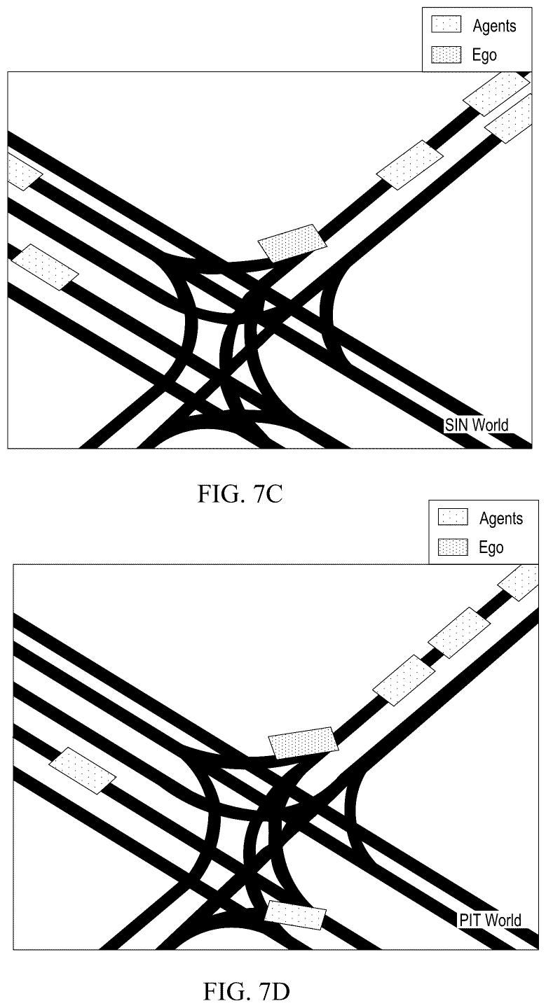

FIGS. 7A and 7B illustrate a given driving scenario that has been provided to a motion planning model that has been trained using driving behavior control parameters specific to Boston, and to Pittsburgh, respectively.

As shown in both FIGS. 7A and 7B, an initial traffic scenario has been unrolled with the Boston and the Pittsburgh world models, respectively, wherein the motion planning model being provided with the initial traffic scenario has been trained on learned driving behavior control parameters from different cities using the series of neural networks. The ego vehicle and agent vehicles are denoted by the Key in both figures. The Boston world model (BOS world) in FIG. 7A illustrates agent vehicles that are more likely to tailgate or maintain a shorter minimum distance between vehicles than the Pittsburgh world model (PIT world) in FIG. 7B.

These world models, illustrated in FIGS. 7A and 7B, are consistent with the driving behavior control parameters shown in FIG. 5 and in the plots pertaining to minimum distance between vehicles in FIGS. 4A and 4B.

FIGS. 7C and 7D illustrate another given driving scenario that has been provided to a motion planning model that has been trained using driving behavior control parameters specific to Singapore, and to Pittsburgh, respectively.

As shown in both FIGS. 7C and 7D, another initial traffic scenario has been unrolled with the Singapore and the Pittsburgh world models, respectively, wherein the motion planning model being provided with the initial traffic scenario has been trained on learned driving behavior control parameters from different cities using the series of neural networks. The ego vehicle and agent vehicles are denoted by the Key in both figures. The Singapore world model (SIN World) in FIG. 7C illustrates agent vehicles that are more likely to have a higher maximum acceleration and higher minimum distance between vehicles than the Pittsburgh world model (PIT World) in FIG. 7D.

These world models, illustrated in FIGS. 7C and 7D, are consistent with the driving behavior control parameters shown in FIG. 5 and in the plots pertaining to minimum distance between vehicles in FIGS. 4C and 4D.

The traffic scenarios in FIGS. 7A-7D being used to train and execute the motion planning model demonstrate that such adaptive world models can be used to significantly improve the accuracy of model-predictive control planners.

FIG. 8 is a flow diagram that illustrates a process of training a series of neural networks, based on a training dataset that is subdivided based on qualitative driving behaviors, to output driving behavior control parameters that can then be used as inputs to a motion planning model, according to some embodiments.

As introduced above, and in order to train a motion planning model that incorporates city-specific driving behaviors and qualitative-specific driving behaviors into the decision making process, thus enabling the motion planning model to output a proposed trajectory of an ego vehicle that is both safe and that abides by said city-specific and qualitative-specific driving behaviors, the following process 800 may be executed.

The following few paragraph first defines certain words and key phrases that should be applied when used within the present disclosure herein. The discussion will then continue with description pertaining to process 800.

As used herein, “qualitative driving behaviors” refers to certain intangible driving behaviors that are interpreted from what is observed in the local environment surrounding the ego vehicle. For example, a characteristically short minimum distance between the ego vehicle and the surrounding vehicle(s) may be interpreted as aggressive driving behavior, while a characteristically long minimum distance between the ego vehicle and the surrounding vehicle(s) may be interpreted as passive driving behavior. In another example, a characteristically fast acceleration of the surrounding vehicle may also be interpreted as aggressive driving behavior, or as driving behavior that has been recorded outside of typically slow rush hour traffic on a city-central highway, while characteristically slow acceleration of the surrounding vehicle may be interpreted as passive driving behavior. As introduced above, the qualitative driving behaviors may be identified as city-specific qualitative driving behaviors if aggressive driving behaviors are consistently recorded within a given geographical area, for example.

Returning now to the flow diagram illustrated in FIG. 8, process 800 corresponds to a moment in time in which a series of neural networks being trained to output driving behavior control parameters. It should be understood that the execution of the motion planning model (see also reference to the motion planning model in block 814 of FIG. 8) thus corresponds to a later moment in time in which the motion planning model is predicting a high-scoring trajectory for the ego vehicle that is currently on the road. The incorporation of computing devices that execute the trained motion planning model are further discussed with regard to FIGS. 10 and 11 herein.

In block 802, computing system 202 is configured to receive a training dataset that includes sensor-based, vehicle driving recordings. In some embodiments, and as additionally described above, the training dataset may refer to the nuPlan benchmark dataset.

In block 804, the sensor-based vehicle driving recordings within the nuPlan training dataset are subdivided into multiple categories, wherein the different categories correspond to different qualitative driving behaviors. For example, the portion of the overall sensor-based, vehicle driving recordings in which aggressive driving behavior was observed are categorized into a first training data subset, while other portions of the overall training dataset that include recordings in which passive driving behavior was observed are categorized into a second training data subset, and so on. By generating several distinct training data subsets, the series of neural networks may then be trained on all of the training data subsets, on a portion of the training data subsets, or on a given training data subset, in order to learn qualitative-specific driving behaviors. FIGS. 9A-9D and the corresponding description herein also relate to categorizing sensor-based vehicle driving recordings into qualitative-specific driving behavior training data subsets.

Blocks 806, 808, 810, and 812 refer to a process of training a series of neural networks to learn driving behavior control parameters of agent vehicles within respective vehicle driving recordings, wherein the learned driving behavior control parameters of the agent vehicles are specific to qualitative driving behaviors that are observed within the overall training dataset. By training the series of neural networks on combinations of the respective training data subsets, the models are configured to provide driving behavior control parameters that may then be applied to other qualitative driving behaviors that were not specifically represented within the training dataset.

Furthermore, by training the series of neural networks on the respective training data subsets to output respective driving behavior control parameters, it ensures that the downstream motion planning model is both city-agnostic and task-agnostic.

As illustrated in blocks 808, 810, and 812 of FIG. 8, the series of neural networks may refer to a combination of machine learning models, such as a feature pyramid network (FPN), a convolutional neural network (CNN), a graph convolutional neural network (GCNN), and a multilayer perceptron (MLP). In block 806, an FPN and a CNN are executed in order to output data indicating features of agent vehicles (e.g., vehicles within the vicinity of the ego vehicle of the given sensor-based vehicle driving recordings), wherein the features may include past trajectories of the agent vehicles.

In block 810, a GCNN is executed in order to output data indicating features of semantic maps of the sensor-based vehicle driving recordings. This may be at least partially applied using LaneGCN, or some similar type of neural network that is configured to extract map features from a lane graph. The GCNN may additionally be used to model interactions between agent vehicles and the map context (e.g., using LaneGCN's Agent-Map Feature Fusion).

As illustrated in FIG. 8, blocks 808 and 810 may be performed in parallel to one another, sequentially to one another, or by any other means that enables the outputs from both blocks 308 and 310 to then be input to the MLP in block 812.

In block 812, an MLP is executed in order to output the learned driving behavior control parameters. In some embodiments, the learned driving behavior control parameters may include at least the following: (1) a target velocity of an ego vehicle; (2) a minimum distance between the ego vehicle and a given surrounding (e.g., agent) vehicle; (3) headway time between the ego vehicle and the given surrounding vehicle (e.g., time between two vehicles passing a specific point on the road, such as a mile marker); (4) maximum acceleration of the given surrounding vehicle; and (5) maximum deceleration of the given surrounding vehicle. Moreover, these driving behavior control parameters may be bounded, have an upper limit, a lower limit, a threshold, or some combination of bounds on the parameters. For example, “acceleration” may have a lower bound of zero miles per hour, as a negative value would intuitively mean “deceleration.”

In block 814, the learned driving behavior control parameters are provided to a motion planning model that models predictive control for an autonomous vehicle, as described above with regard to block 314 in FIG. 3.

Furthermore, process 800 depicts training the series of neural networks with a K-way softmax loss to predict agent behaviors as parameterized driving behavior controls from one of K qualitative driving behaviors, wherein the series of neural networks may be configured as a classifier model. However, instead of discretizing predictions that are output by the series of neural networks into one of K classes, the series of neural networks may be configured as a regression model, which may directly predict the driving behavior control parameters.

FIG. 9A is a t-SNE plot, depicting driving behavior control parameters by city, according to some embodiments.

FIGS. 9A, and FIG. 9B discussed below, illustrate certain clusters that are either city-based driving behaviors or qualitative driving behaviors, or both. Such plots, which illustrate the training dataset in visual ways so as to draw both quantitative and qualitative conclusions about driving behaviors that were observed from the sensor-based, vehicle driving recordings, further confirm that training a series of neural networks to learn driving behavior control parameters are of vital importance as inputs to a motion planning model.

As shown in FIG. 9A, certain driving characteristics are present even within a given geographical area. For example, agent vehicles in Boston may exhibit tailgating behaviors with the city but more cautious driving behavior on highways. As such, each individual sensor-based vehicle driving recording is optimized using the equation

$${θ}^{Target} = {arg min}_{θ} {‖ {X}_{SIM} ( θ ) - {X}_{L O G} ‖}_{2}^{2} .$$

Specifically in FIG. 9A, the plot is used to visualize a set of recording-specific driving behavior control parameters {θ} with t-SNE, wherein different markers within the plot denote different geographical areas.

Furthermore, rather than training the series of neural networks to directly regress these driving behavior control parameters, the problem may be reframed as a discrete classification task. For example, the set of {θ} can be clustered into K clusters, and the series of neural networks is then trained with a K-way softmax loss.

FIG. 9B is another t-SNE plot, depicting per-scenario driving behavior control parameters by qualitative driving behaviors, according to some embodiments.

In the t-SNE plot shown in FIG. 9B, per-driving-scenario driving behavior control parameters are clustered using K-means, allowing for different clusters to be visualized. Each respective cluster represents a unique qualitative driving behavior. Moreover, the plot in FIG. 9B also compares city-based clusters shown in FIG. 9A to the qualitative-behavior-based clusters shown in FIG. 9B, as indicated by the Key.

FIG. 9C is a plot depicting the portion of agent vehicles within the nuPlan training dataset that exhibit short minimum distances between vehicles, and FIG. 9D is a plot depicting the portion of agent vehicles within the nuPlan training dataset that exhibit long minimum distances between vehicles, according to some embodiments.

The plot in FIG. 9C further interprets the “aggressive agent vehicle” cluster that is visualized in FIG. 9B by plotting the minimum distance between vehicles on the X axis vs percent of vehicles within the cluster along the Y axis. The plot in FIG. 9D further interprets the “passive agent vehicle” cluster that is visualized in FIG. 9B by plotting the minimum distance between vehicles on the X axis vs percent of vehicles within the cluster along the Y axis.

As shown in FIGS. 9C and 9D, the “aggressive agent vehicle” cluster has a lower average minimum distance between vehicles than the “passive agent vehicle” cluster, thus validating the K-means clusters described above encode unique city-agnostic driving behaviors.

The methods and systems disclosed herein can be used in many different applications of autonomous driving, such as for fully autonomous vehicles, delivery robots, etc. FIG. 10 depicts a schematic diagram of an interaction between a computer-controlled machine 1000 and a control system 1002. Computer-controlled machine 1000 includes actuator 1004 and sensor 1006. Actuator 1004 may include one or more actuators and sensor 1006 may include one or more sensors. Sensor 1006 is configured to sense a condition of computer-controlled machine 1000. Sensor 1006 may be configured to sense ID and/or OOD data, and the corresponding processors can be configured to determine whether the data is ID or OOD according to the teachings herein. Sensor 1006 may be configured to encode the sensed condition into sensor signals 1008 and to transmit sensor signals 1008 to control system 1002. Non-limiting examples of sensor 1006 include a camera, video sensor, radar, LiDAR, ultrasonic and motion sensors, temperature sensors, and the like. In one embodiment, sensor 1006 is an optical sensor configured to sense optical images of an environment proximate to computer-controlled machine 1000.

Control system 1002 is configured to receive sensor signals 1008 from computer-controlled machine 1000. As set forth below, control system 1002 may be further configured to compute actuator control commands 1010 depending on the sensor signals and to transmit actuator control commands 1010 to actuator 1004 of computer-controlled machine 1000.

As shown in FIG. 10 control system 1002 includes receiving unit 1012. Receiving unit 1012 may be configured to receive sensor signals 1008 from sensor 1006 and to transform sensor signals 1008 into input signals x. In an alternative embodiment, sensor signals 1008 are received directly as input signals x without receiving unit 1012. Each input signal x may be a portion of each sensor signal 1008. Receiving unit 1012 may be configured to process each sensor signal 1008 to product each input signal x. Input signal x may include data corresponding to an image recorded by sensor 1006.

Control system 1002 includes a motion planning model 1014. Motion planning model 1014 may be configured to classify input signals x into one or more labels using at least the learned driving behavior control parameters described above. In embodiments in which motion planning model 1014 is configured as a classifier, the model is then also configured to be parametrized by parameters. Parameters may be stored in and provided by non-volatile storage 1016. Motion planning model 1014 is configured to determine a planned trajectory of the ego vehicle, such as vehicle 1100 shown in FIG. 11. Thus output signals y, shown in FIG. 10 refers to ego vehicle trajectory proposals for planned motion control of the autonomous vehicle. Each output signal y includes information that assigns one or more labels to each input signal x. Motion planning model 1014 may transmit the highest scoring ego vehicle planned trajectory proposal to conversion unit 1018. Conversion unit 1018 is configured to covert output signals y into actuator control commands 1010. Control system 1002 is configured to transmit actuator control commands 1010 to actuator 1004, which is configured to actuate computer-controlled machine 1000 in response to actuator control commands 1010. In another embodiment, actuator 1004 is configured to actuate computer-controlled machine 1000 based directly on output signals y.

Upon receipt of actuator control commands 1010 by actuator 1004, actuator 1004 is configured to execute an action corresponding to the related actuator control command 1010. Actuator 1004 may include a control logic configured to transform actuator control commands 1010 into a second actuator control command, which is utilized to control actuator 1004. In one or more embodiments, actuator control commands 1010 may be utilized to control a display instead of or in addition to an actuator.

In another embodiment, control system 1002 includes sensor 1006 instead of or in addition to computer-controlled machine 1000 including sensor 1006. Control system 1002 may also include actuator 1004 instead of or in addition to computer-controlled machine 1000 including actuator 1004.

As shown in FIG. 10, control system 1002 also includes processor 1020 and memory 1022. Processor 1020 may include one or more processors. Memory 1022 may include one or more memory devices. The motion planning model 1014 of one or more embodiments may be implemented by control system 1002, which includes non-volatile storage 1016, processor 1020 and memory 1022.

Non-volatile storage 1016 may include one or more persistent data storage devices such as a hard drive, optical drive, tape drive, non-volatile solid-state device, cloud storage or any other device capable of persistently storing information. Processor 1020 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 1022. Memory 1022 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 1020 and memory 1022 may be configured to provide collected data to one or more other computing devices that are configured to train and/or validate the machine learning model within domain-specific embodiments shown throughout FIGS. 10 and 11. Such collected data may be used to generate training datasets and validation datasets for various stages in preparing and executing a motion planning model into industry-grade applications. Within a context described herein with regard to motion planning, processor 1020 and memory 1022 may be coupled to or otherwise remotely connected to computing devices that may then conduct ego vehicle planned trajectory proposals and/or scorings, such as those described above.

Processor 1020 may be configured to read into memory 1022 and execute computer-executable instructions residing in non-volatile storage 1016 and embodying one or more machine learning algorithms and/or methodologies of one or more embodiments. Non-volatile storage 1016 may include one or more operating systems and applications. Non-volatile storage 1016 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 1020, the computer-executable instructions of non-volatile storage 1016 may cause control system 1002 to implement one or more of the machine learning algorithms and/or methodologies as disclosed herein. Non-volatile storage 1016 may also include machine learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 11 depicts a schematic diagram of control system 1002 configured to control vehicle 1100, which may be an at least partially autonomous vehicle or an at least partially autonomous robot. Vehicle 1100 includes actuator 1004 and sensor 1006. Sensor 1006 may include one or more video sensors, cameras, radar sensors, ultrasonic sensors, LiDAR sensors, and/or position sensors (e.g. GPS). One or more of the one or more specific sensors may be integrated into vehicle 1100. Alternatively or in addition to one or more specific sensors identified above, sensor 1006 may include a software module configured to, upon execution, determine a state of actuator 1004. One non-limiting example of a software module includes a weather information software module configured to determine a present or future state of the weather proximate vehicle 1100 or other location.

Motion planning model 1014 of control system 1002 of vehicle 1100 may be configured to detect objects in the vicinity of vehicle 1100 dependent on input signals x. In such an embodiment, output signal y may include information characterizing the vicinity of objects to vehicle 1100. Actuator control command 1010 may be determined in accordance with this information. The actuator control command 1010 may be used to avoid collisions with the detected objects.

In embodiments where vehicle 1100 is an at least partially autonomous vehicle, actuator 1004 may be embodied in a brake, a propulsion system, an engine, a drivetrain, or a steering of vehicle 1100. Actuator control commands 1010 may be determined such that actuator 1004 is controlled such that vehicle 1100 avoids collisions with detected objects. Detected objects may also be classified according to what motion planning model 1014 deems them most likely to be, such as pedestrians or trees. The actuator control commands 1010 may be determined depending on the classification. In a scenario where an adversarial attack may occur, the system described above may be further trained to better detect objects or identify a change in lighting conditions or an angle for a sensor or camera on vehicle 1100.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for a network of machine learning models, comprising:
receiving a training dataset comprising a plurality of sensor-based, vehicle driving recordings;
categorizing the training dataset into subsets, wherein respective ones of the training data subsets comprise sensor-based driving recordings of the plurality that pertain to a corresponding geographical area;
training, for respective ones of the training data subsets, a series of neural networks to learn driving behavior control parameters of surrounding vehicles, wherein the driving behavior control parameters correspond to the respective geographical area; and
providing data indicating the driving behavior control parameters to a motion planning model that models predictive control for an autonomous vehicle.

2. The computer-implemented method of claim 1, wherein the driving behavior control parameters are bounded parameters that comprise:
target velocity of an ego vehicle;
minimum distance between the ego vehicle and a given surrounding vehicle;
headway time between the ego vehicle and the given surrounding vehicle;
maximum acceleration of the given surrounding vehicle; and
maximum deceleration of the given surrounding vehicle.

3. The computer-implemented method of claim 1, wherein the geographical area is a city, county, or other designated region with a radius of at least 100 m.

4. The computer-implemented method of claim 1, wherein the sensor-based, vehicle driving recordings of the training dataset are augmented with metadata about one or more of the following for respective driving scenarios within the sensor-based, vehicle driving recordings:
a semantic map;
one or more objects within a local environment of an ego vehicle; and
a status of a traffic light.

5. The computer-implemented method of claim 1, wherein the sensor-based, vehicle driving recordings of the training dataset are auto-labeled using an offline perception system to differentiate between one or more of:
the surrounding vehicles;
a bicycle;
a pedestrian;
a traffic cone;
a barrier; and
a construction zone sign.

6. The computer-implemented method of claim 1, wherein the training, for respective ones of the training data subsets, the series of neural networks comprises:
for a given one of the training data subsets,
providing the sensor-based driving recordings that pertain to the corresponding geographical area to a Feature Pyramid Network (FPN) and a Convolutional Neural Network (CNN); and
executing the FPN and the CNN to output data indicating features of the surrounding vehicles.

7. The computer-implemented method of claim 6, wherein the training, for respective ones of the training data subsets, the series of neural networks further comprises:
for a given one of the training data subsets,
providing the sensor-based driving recordings that pertain to the corresponding geographical area to a Graph Convolutional Neural Network (GCNN); and
executing the GCNN to output data indicating features of semantic maps of the sensor-based driving recordings.

8. The computer-implemented method of claim 7, wherein the training, for respective ones of the training data subsets, the series of neural networks further comprises:
for a given one of the training data subsets,
providing the data indicating features of the surrounding vehicles and the data indicating features of the semantic maps to a Multilayer Perceptron (MLP); and
executing the MLP to output the driving behavior control parameters.

9. The computer-implemented method of claim 1, wherein the method further comprises:
categorizing the training dataset into additional subsets, wherein respective ones of the additional training data subsets comprise sensor-based driving recordings of the plurality that indicate a given qualitative driving behavior of the surrounding vehicles;
training, for respective ones of the additional training data subsets, the series of neural networks to learn additional driving behavior control parameters of the surrounding vehicles; and
providing data indicating the additional driving behavior control parameters to the motion planning model.

10. The computer-implemented method of claim 1, wherein the method further comprises validating the series of neural networks, comprising:
providing a previously unused training data subset to the series of neural networks; and
executing the series of neural networks to output additional driving behavior control parameters.

11. The computer-implemented method of claim 1, wherein the method further comprises executing the motion planning model, based on the data indicating the driving behavior control parameters of the surrounding vehicles, to output a planned trajectory of the autonomous vehicle for a future amount of time, wherein the executing the motion planning model comprises:
generating a plurality of predicted trajectories of the surrounding vehicles;
calculate safety scores with respect to the autonomous vehicle for respective ones of the predicted trajectories; and
provide the planned trajectory of the autonomous vehicle that has a high safety score.

12. A computer-implemented method for a network of machine learning models, comprising:
receiving a training dataset comprising a plurality of sensor-based, vehicle driving recordings;
categorizing the training dataset into subsets, wherein respective ones of the training data subsets comprise sensor-based driving recordings of the plurality that indicate a given one of qualitative driving behaviors of surrounding vehicles;
training a series of neural networks, based on the training data subsets, to learn driving behavior control parameters of the surrounding vehicles, wherein the driving behavior control parameters correspond to the respective qualitative driving behaviors; and
providing data indicating the driving behavior control parameters to a motion planning model that models predictive control for an autonomous vehicle.

13. The computer-implemented method of claim 12, wherein:
the training dataset is categorized into K number of qualitative driving behaviors; and
the training the series of neural networks further comprises executing the series of neural networks based on a K-way softmax loss.

14. The computer-implemented method of claim 12, wherein the qualitative driving behaviors comprise one or more of:
a characteristically short minimum distance between an ego vehicle and a given surrounding vehicle;
a characteristically long minimum distance between the ego vehicle and the given surrounding vehicle;
a characteristically fast acceleration of the given surrounding vehicle; and
a characteristically slow acceleration of the given surrounding vehicle.

15. The computer-implemented method of claim 12, wherein the driving behavior control parameters are bounded parameters that comprise:
target velocity of an ego vehicle;
minimum distance between the ego vehicle and a given surrounding vehicle;
headway time between the ego vehicle and the given surrounding vehicle;
maximum acceleration of the given surrounding vehicle; and
maximum deceleration of the given surrounding vehicle.

16. The computer-implemented method of claim 12, wherein the method further comprises executing the motion planning model, based on the data indicating the driving behavior control parameters of the surrounding vehicles, to output a planned trajectory of the autonomous vehicle for a future amount of time, wherein the executing the motion planning model comprises:
generating a plurality of predicted trajectories of the surrounding vehicles;
calculate safety scores with respect to the autonomous vehicle for respective ones of the predicted trajectories; and
provide the planned trajectory of the autonomous vehicle that has a high safety score.

17. A computer-implemented method for a network of machine learning models, comprising:
receiving a training dataset comprising a plurality of sensor-based, vehicle driving recordings;
categorizing the training dataset into subsets, wherein respective ones of the training data subsets comprise sensor-based driving recordings of the plurality that pertain to a given one of qualitative driving behaviors of surrounding vehicles within a given geographical area;
training, for respective ones of the training data subsets, a series of neural networks to learn driving behavior control parameters of the surrounding vehicles, wherein the driving behavior control parameters correspond to the respective geographical area; and
providing data indicating the driving behavior control parameters to a motion planning model that models predictive control for an autonomous vehicle.

18. The computer-implemented method of claim 17, wherein the geographical area is a city, county, or other designated region with a radius of at least 100 m.

19. The computer-implemented method of claim 17, wherein the driving behavior control parameters are bounded parameters that comprise:
target velocity of an ego vehicle;
minimum distance between the ego vehicle and a given surrounding vehicle;
headway time between the ego vehicle and the given surrounding vehicle;
maximum acceleration of the given surrounding vehicle; and
maximum deceleration of the given surrounding vehicle.

20. The computer-implemented method of claim 17, wherein the qualitative driving behaviors comprise one or more of:
a characteristically short minimum distance between an ego vehicle and a given surrounding vehicle;
a characteristically long minimum distance between the ego vehicle and the given surrounding vehicle;
a characteristically fast acceleration of the given surrounding vehicle; and
a characteristically slow acceleration of the given surrounding vehicle.
